(19) United States
(12) Patent Application Publication
(10) Pub. No.: US 2026/0348724 A1
(43) Pub. Date: Nov. 5, 2026

(54) IMAGING DEVICE, DISTANCE MEASURING DEVICE, INSPECTING DEVICE, IMAGING METHOD, DISTANCE MEASURING METHOD, INSPECTING METHOD, AND PROGRAM

(71) Applicant: Panasonic Intellectual Property Management Co., Ltd., Osaka (JP)

(72) Inventors: Masato TAKEMOTO, OSAKA FU (JP); Shinzo KOYAMA, OSAKA FU (JP)

(21) Appl. No.: 19/118,642

(22) PCT Filed: Jan. 29, 2024
(86) PCT No.: PCT/JP2024/002639

§ 371 Date: Apr. 4, 2025

(30) Foreign Application Priority Data
Jan. 30, 2023 (JP) 2023-012064

(51) Int. Cl. G01B 11/25; G01C 3/06

(52) U.S. Cl. CPC G01B 11/25; G01C 3/06

(57) ABSTRACT

An imaging method includes: computing a complementary color to the color of an object; generating a random dot pattern of the complementary color and projecting the pattern onto the object; and imaging the object and identifying an image region of the object using a random dot pattern obtained by the imaging.

### BACKGROUND

The present disclosure relates to an imaging device and an imaging method, a distance measuring device and a distance measuring method that measure the distance to an object to be measured (hereinafter simply referred to as an “object”), and an inspecting device and an inspecting method that detect a defect of the object, and programs.

A distance measuring device that measures the distance to an object by projecting pattern light onto the object is known.

For example, Japanese Unexamined Patent Publication No. 2013-190394 describes a distance measuring device in which pattern light having randomized luminance grayscale levels is projected onto an object. Specifically, the cited patent document describes a distance measuring device including: a pattern illuminating device having a diffraction optical element that emits, to an object, pattern light in which pixels having a luminance distribution of three or more grayscale levels are arranged at random; a compound-eye imaging device; and a controller that computes the distance to the object to be measured by calculating the parallax.

When a random dot pattern of white light in which pixels having a luminance distribution of three or more grayscale levels are arranged at random is projected onto an object under uniform light, for example, there may arise an occurrence in some pixels that the signal may be discontinued at the saturation value (upper limit) or the black level (lower limit) of an image sensor, causing collapsing of the dot pattern and decreasing the parallax detection rate.

In view of the above problem, an objective of the present disclosure is providing a distance measuring device in which the signal is not discontinued at the upper limit or lower limit of an image sensor, thereby preventing decrease in parallax detection rate.

### SUMMARY

A distance measuring device according to a main mode of the present disclosure includes: a first imaging unit and a second imaging unit arranged side by side so that their viewing fields overlap each other; a projecting unit configured to project random dot pattern light of a complementary color to an object onto a range of the overlap of the viewing fields; and a measuring unit configured to perform stereo correspondence processing for first images acquired by the first imaging unit and the second imaging unit to measure the distance to the surface of the object onto which the random dot pattern light is projected.

According to the present disclosure, by imaging an object while projecting a random dot pattern of a complementary color onto the object, the dot pattern can be detected stably irrespective of the spectral reflectance of the object, whereby decrease in parallax detection rate can be prevented.

### BRIEF DESCRIPTION OF THE DRAWINGS

FIG. 1 is a block diagram schematically showing the manner of projection of pattern light onto an object and imaging.

FIG. 2 is a block diagram showing a configuration example of a distance measuring device and its peripherals.

FIG. 3 is a flowchart showing an operation example of the distance measuring device.

FIG. 4 is a view showing the results of simulation for a configuration example of the first embodiment and a comparative example.

FIG. 5 is a view showing the results of simulation for the configuration example of the first embodiment and the comparative example.

FIG. 6 is a conceptual view showing the operation and action of a distance measuring device of the first embodiment.

FIG. 7 is a view for explaining one of the other embodiments.

FIG. 8 is a view for explaining the one of the other embodiments.

FIG. 9 is a view showing an example of an integrated dot pattern.

FIG. 10 is a block diagram showing an alteration of FIG. 1.

FIG. 11 is a block diagram showing a configuration example of an imaging device according to the second embodiment.

FIG. 12 is a flowchart showing an example (No. 1) of an imaging method.

FIG. 13 is a flowchart showing another example (No. 2) of the imaging method.

FIG. 14 is a flowchart showing yet another example (No. 3) of the imaging method.

FIG. 15 is a block diagram showing a configuration example of an inspecting device according to the third embodiment.

FIG. 16 is a flowchart showing an example (No. 1) of an inspecting method.

FIG. 17 is a flowchart showing another example (No. 2) of the inspecting method.

FIG. 18 is a flowchart showing yet another example (No. 3) of the inspecting method.

FIG. 19 is a block diagram showing a configuration example of a distance measuring device according to the fourth embodiment.

FIG. 20 is a flowchart showing an example (No. 1) of a distance measuring method.

FIG. 21 is a flowchart showing another example (No. 2) of the distance measuring method.

FIG. 22 is a flowchart showing yet another example (No. 3) of the distance measuring method.

FIG. 23 is a block diagram showing another configuration example of the distance measuring device.

FIG. 24 is a flowchart showing an alteration of the distance measuring method.

FIG. 25 is a flowchart showing an example of detailed processing of step S24 in FIG. 24.

### DETAILED DESCRIPTION

Embodiments of the present disclosure will be described hereinafter in detail with reference to the accompanying drawings.

Note that description of the embodiments to follow is essentially a mere illustration and by no means intended to restrict the present invention, applications thereof, or uses thereof. That is, numerical values, shapes, components, disposed positions and connecting styles of the components, and the like shown in the embodiments below are examples and by no means purport to limit the present disclosure. Therefore, among components in the embodiments below, a component that is not described in an independent claim representing a highest concept of the present disclosure will be described as an optional component.

A main body of a device, a system, or a method according to the present disclosure includes a computer. This computer executes a program, whereby the function of the main body of the device, the system, or the method is implemented. The computer includes a processor operating according to the program as a main hardware constituent. Any kind of processor may be used as far as it can implement the function by executing the program. The processor is constituted by one or a plurality of electronic circuits including a semiconductor integrated circuit (IC) or an LSI (large scale integration). Although such a circuit is called herein as an LC or an LSI, it may be a system LSI, a VLSI (very large scale integration), or an ULSI (ultra large scale integration) as called differently depending on the degree of integration. A field programmable gate array (FPGA) programmed after the manufacture of an LSI, or a reconfigurable logic device capable of reconfiguring the connection relationship inside an LSI or setting up circuit segments inside an LSI can also be used for the same purpose. The plurality of electronic circuits may be integrated into one chip or mounted on a plurality of chips. The plurality of chips may be integrated into one device or provided in a plurality of devices. The program is recorded in a computer-readable non-transitory recording medium such as a ROM, an optical disc, and a hard disk drive. The program may be stored in a recording medium in advance, or may be supplied to a recording medium through a wide-area network including the Internet.

### First Embodiment

This embodiment relates to a distance measuring device that measures the distance to an object by projecting pattern light onto the object from a projecting unit, and is used for a stereo camera, for example. More specifically, the distance measuring device of this embodiment divides the projection range into a plurality of divided regions, adjusts the light intensity of two or more wavelength bands for each divided region independently, and projects the light onto the projection range, to perform distance measuring operation.

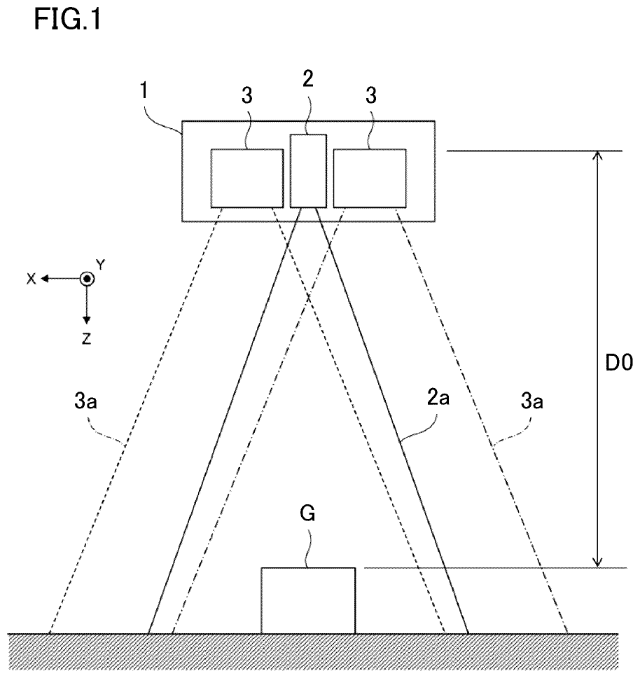

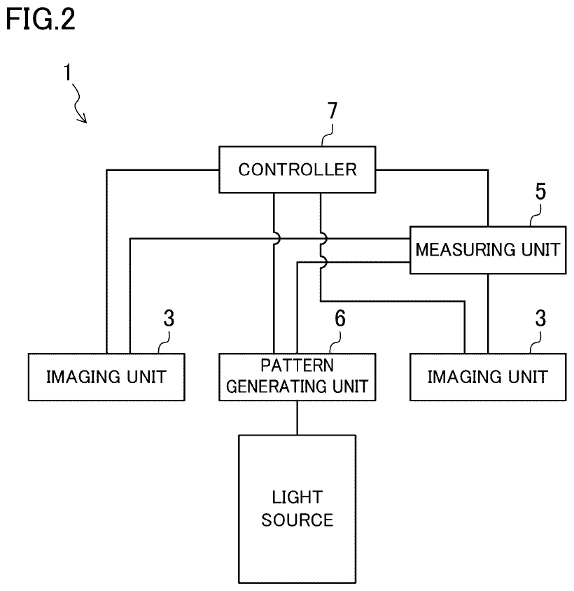

As shown in FIG. 1, a distance measuring device 1 includes a projecting unit 2 and a plurality of imaging units 3. Also, as shown in FIG. 2, the distance measuring device 1 includes a measuring unit 5, a pattern generating unit 6, a controller 7, and a light source constituting the projecting unit 2. The functions of the measuring unit 5, the pattern generating unit 6, and the controller 7 are implemented by the processor described above.

### Projecting Unit

The projecting unit 2 has a light source (see FIG. 2) and projects uniform light onto a predetermined projection range 2a under the control of the controller 7. The uniform light can be a kind of light having uniform luminous intensity in the projection range (e.g., free from a difference in luminance, like a dot pattern, when light is projected onto a plane normal to the light axis), and is white light, for example. The predetermined projection range 2a can be set arbitrarily as a range including the object G.

Moreover, the projecting unit 2 is configured to be able to project multiwavelength pattern light onto the predetermined projection range 2a under the control of the controller 7.

The light source used for the projecting unit 2 is not specifically limited, but a conventionally known one (e.g., a DLP projector and a liquid crystal projector) can be used. For the projector, a laser, an LED, or a mercury lamp, for example, may be used.

When the spectral reflectance of the object G is known, projection of uniform light can be skipped. Details will be described in the operation of a parallax information generating device later.

### Imaging Unit

A plurality of imaging units 3 are arranged side by side so that their viewing fields 3a overlap each other. As shown in FIG. 1, the predetermined projection range 2a is set to include the overlap region of the viewing fields 3a.

Each of the imaging units 3 images the range of the viewing field 3a under control of the controller 7 and outputs the imaged results to the measuring unit 5. An RGB camera, for example, can be used as the imaging unit 3. Imaging elements used for the imaging unit 3 are not specifically limited, but conventionally known elements (e.g., image sensors (photodiodes)) can be used.

In this example, two imaging units 3 are arranged side by side. That is, an example of a twin-lens stereo camera is shown. The number of imaging units 3 is not limited to two, but may be three or more.

### Measuring Unit

The measuring unit 5, receiving an image (hereinafter also called the “second image”) captured by one of the imaging units 3 under projection of uniform light onto the object G by the projecting unit 2, divides a region R in which the object G is imaged, in the second image into a plurality of divided regions RD. The measuring unit 5 then calculates a complementary color for each divided region RD and outputs the results to the pattern generating unit 6.

The “complementary color” as used herein refers to, not the complementary color as expressed with reference to the luminosity of humans, but the complementary color in the spectral sensitivity of each pixel (e.g., R pixel, G pixel, or B pixel) of a photodiode (not shown) disposed in the imaging units 3.

Also, the “complementary color for each divided region RD” as used herein is obtained by determining a reference color by performing statistical processing such as the average value, the median value, and the mode value of the colors of pixels included in the divided region RD, and computing the complementary color to the reference color.

The measuring unit 5 also acquires an image (hereinafter also called the “first image”) captured by each of the plurality of imaging units 3 in the state of projection of random dot pattern light (also simply called the “random dot pattern”) of the complementary color generated by the pattern generating unit 6. The measuring unit 5 then performs stereo correspondence processing for the first images, to measure a distance DO to the surface of the object onto which the random dot pattern light is projected. The stereo correspondence processing can be performed by calculating the matching cost of two images using SSD, SAD, NCC, and the like for each block region and selecting the parallax at which the cost is smallest.

### Pattern Generating Unit

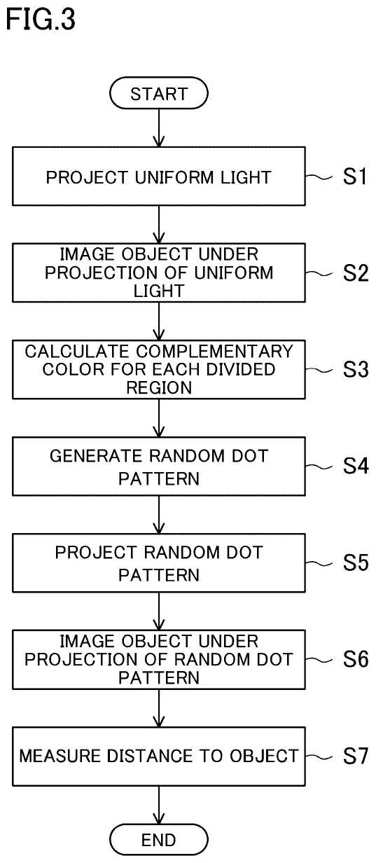

The pattern generating unit 6 generates a random dot pattern of light corresponding to the calculated complementary color (hereinafter called the “complementary color light”) for each projection region corresponding to the divided region RD based on the calculation results from the measuring unit 5. The correspondence between the divided region RD and the projection region can be determined by employing homography transformation, for example, using the spatial positional relationship between the imaging unit 3 and the projecting unit 2 and optical parameters. An example of simulation results of a random dot pattern generated by the pattern generating unit 6 is shown in the middle row of the left column in FIG. 3. Specific description on FIG. 3 will be made later.

### Controller

The controller 7 has a function of controlling the operation of the distance measuring device 1, and is constituted by a CPU (processor) and a memory that stores programs for operating the CPU and results of processing by the CPU, for example. The controller 7 has programs for controlling the operations of the projecting unit 2, the imaging units 3, the measuring unit 5, and the pattern generating unit 6. Note that the programs are not necessarily stored in the memory in advance, but may be presented through electric lines such as the Internet or from a physical non-transitory recording medium such as a memory card. Moreover, a setting receiving unit such as a keyboard may be provided to receive setting from the operator, thereby making the control method changeable. Also, the controller 7 may take in the functions of the measuring unit 5 and the pattern generating unit 6. That is, the functions of the measuring unit 5, the pattern generating unit 6, and the controller 7 may be implemented by the same processor.

The controller 7 executes (1) the control of making the projecting unit 2 project uniform light and also making the imaging units 3 perform imaging operation and (2) the control of making the projecting unit 2 project a random dot pattern of a complementary color and also making the imaging unit 3 perform imaging operation.

Note that part or all of the functions of the controller 7 may be implemented by a hardware circuit and the like. Also, the functions of the controller 7, the measuring unit 5, and the pattern generating unit 6 may be implemented by a single or a plurality of common microcomputers, CPUs, or the like.

Details of the processing in the controller 7 will be described more specifically in the operation of the parallax information generating device as follows.

### Operation of Parallax Information Generating Device

The operation of the parallax information generating device will be described hereinafter with reference to the flowchart of FIG. 3.

In step S1 in FIG. 3, the controller 7 instructs the projecting unit 2 to project uniform light. Also, concurrently with step S1, the controller 7 instructs the imaging units 3 to perform imaging (step S2).

In response to the above, the projecting unit 2 executes projection of uniform light onto the projection range 2a, and each imaging unit 3 executes imaging of the viewing field 3a including the projection range 2a onto which the uniform light is being projected. The second image captured by the imaging unit 3 is transmitted to the measuring unit 5.

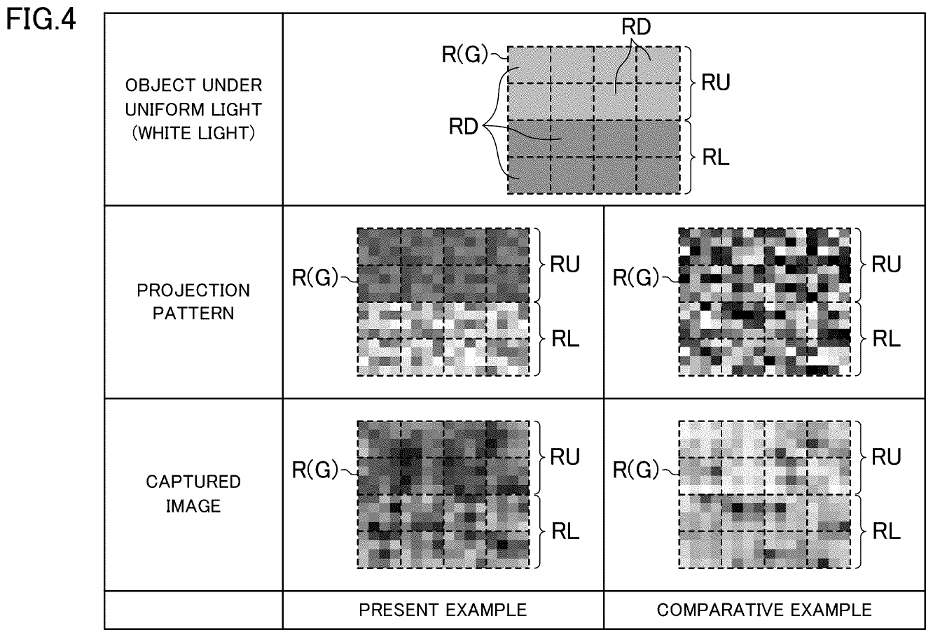

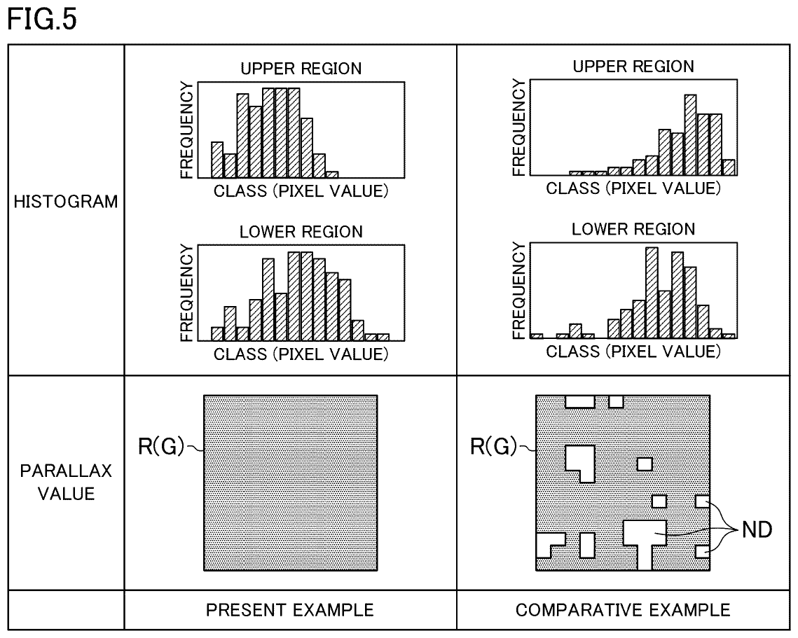

FIGS. 4 and 5 show the results of simulation. An example of the object G imaged under the uniform light is shown in the top row in FIG. 4. Under the uniform light (white light), the upper-half region (hereinafter called the upper region RU) is yellow-green, and the lower-half region (hereinafter called the lower region RL) is blue.

In next step S3, the measuring unit 5 divides the second image received from the imaging unit 3 into a plurality of divided regions, and calculates a corresponding complementary color for each divided region RD. In the example of FIG. 4, the measuring unit 5 divides the second image into equal “4 rows×4 columns=16” divided regions RD, and calculates a corresponding complementary color for each divided region. That is, in the example of FIG. 4, the upper region RU is divided into 2 rows×4 columns=8 regions, the lower region RL is divided into 2 rows×4 columns=8 regions, and a complementary color is calculated for each divided region RD. In this example (see left column, middle row in FIG. 4), complementary colors different between the upper region RU and the lower region RL are obtained as the calculation results.

In next step S4, the pattern generating unit 6 generates a random dot pattern corresponding to the complementary color calculated by the measuring unit 5 for each divided region RD, and also sets the emission intensity of the random dot pattern.

The method of determining the emission intensity of the multiwavelength pattern light constituting the random dot pattern is not specifically limited, but can be set as follows, for example.

First, the pattern generating unit 6 determines the maximum and minimum values for each pixel or for each region of several pixels×several pixels (hereinafter also collectively called “for each pixel”) using equations (1) and (2) below.

Maximum value=([illuminance of uniform light]×[pixel value at saturation of photodiode used in imaging unit 3])/[pixel value obtained by imaging under uniform light] (1)

Minimum value=([illuminance of uniform light]×[pixel value at black level of photodiode used in imaging unit 3])/[pixel value obtained by imaging under uniform light] (2)

The pattern generating unit 6 then randomly assigns an illuminance of a multiwavelength random dot within the range determined in equations (1) and (2) above to each pixel.

The example according to this embodiment is shown in the left column in FIG. 4, and an example of the random dot pattern of the complementary color light is shown in the middle row. In the right column in FIG. 4, a comparative example is shown, and an example of the random dot pattern of white light is shown in the middle row. In comparison of the left column with the right column, it is found that, in the left column, since the complementary color is reflected in the random dot pattern light, the entire tint is different between the upper region and the lower region.

Note that, when the spectral reflectance of the object G is known and the random dot pattern light of the complementary color of the object is prepared in advance, steps S1 to S4 can be omitted.

In next step S5, the controller 7 instructs the projecting unit 2 to project the random dot pattern light generated by the pattern generating unit 6. Also, concurrently with step S5, the controller 7 instructs the imaging units 3 to perform imaging (step S6). Examples of captured images in the present example and the comparative example, after subjected to debayer processing, are shown in the bottom row in FIG. 4.

In response to the above, the projecting unit 2 executes projection of the random dot pattern light onto the projection range 2a, and each imaging unit 3 executes imaging of the object G onto which the random dot pattern light is being projected. The captured first images are output to the measuring unit 5. That is, two or more first images different from each other are output from the plurality of imaging units 3. For example, when there are two imaging units 3, two first images are input into the measuring unit 5.

In next step S7, the measuring unit 5 measures the distance to the object G using the first images captured by the imaging units 3 in step S6.

In the top row in FIG. 5, examples of histograms of the first image in the upper region RU and the lower region RL in the present example (projection of random dot pattern light) and the comparative example (projection of white uniform light) are shown. In the comparative example, in the histograms, there are some pixels in which the signal is discontinued at the upper or lower limit, causing collapsing of the dot pattern, thereby failing to detect the parallax in such pixels as shown in the bottom row of the right column in FIG. 5 (see ND in FIG. 5). By contrast, in the present example, it has been confirmed that, since the histograms are avoided from reaching the upper or lower limit, decrease in parallax detection rate is prevented.

As described above, in this embodiment, (1) the projecting unit 2 projects uniform light onto the projection range 2a including the object G, (2) the imaging unit 3 captures the second image of the viewing field 3a including the projection range 2a onto which the uniform light is being projected, (3) the measuring unit 4 divides the second image into a plurality of divided regions RD and calculates a corresponding complementary color for each divided region RD, (4) the pattern generating unit 6 generates a random dot pattern of the complementary color for each divided region RD based on the calculation results in the measuring unit 5, (5) the projecting unit 2 projects the random dot pattern light generated by the measuring unit 5 onto the projection range 2a, (6) the imaging units 3 capture the first images of the projection range 2a onto which the random dot pattern light is being projected, and (7) the measuring unit 5 measures the distance to the object G based on the first images.

As a result, when photodiodes are used as the image sensors in the imaging unit 3, for example, it is possible to avoid, in the photodiodes, the occurrence in some pixels that the signal is discontinued at the upper or lower limit. This can prevent decrease in parallax detection rate.

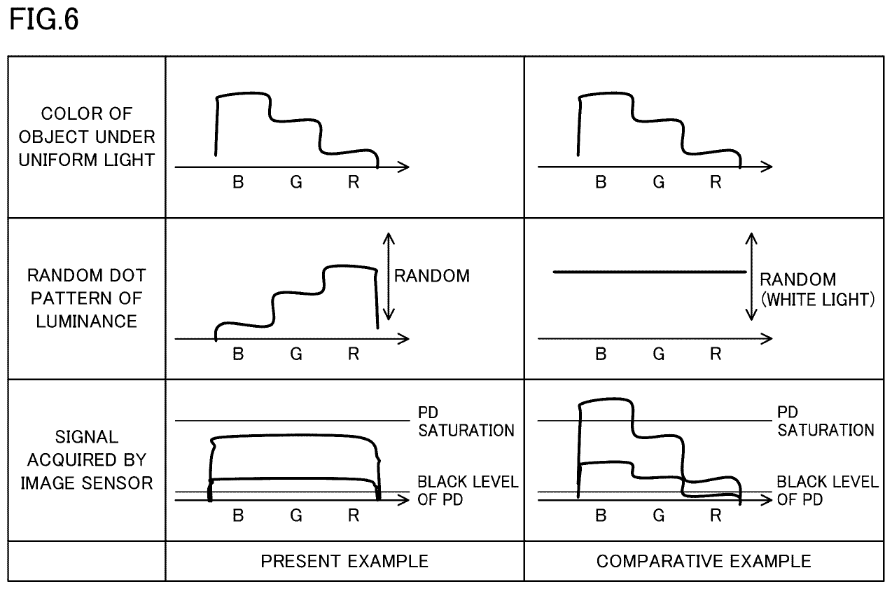

The effects of this embodiment will be described more specifically with reference to FIG. 6. FIG. 6 shows conceptual views of the present example (this embodiment) in the left column and conceptual views of the comparative example in the right column. In this case, in both the present example and the comparative example, spectral distributions as shown in the top row are obtained when uniform light is projected.

In the comparative example (right column), a “random dot pattern of uniform light (white light)” shown in the middle row is used. With this, as shown in the bottom row in the right column, there arises the occurrence in a photodiode of the imaging unit 3 that the signal exceeds the upper limit (saturation value) or falls below the lower limit (black level) of the photodiode. As a result, the dot pattern collapses, causing decrease in parallax detection rate.

By contrast, in this embodiment, the “random dot pattern light of complementary color” as shown in the middle row in the left column is used. That is, used is a random dot pattern characterized in that the color of the object and the intensity level of the spectral distribution are opposite to each other. With this, as shown in the bottom row in the left column, in a photodiode of the imaging unit 3, it is possible to avoid the occurrence that the signal exceeds the upper limit (saturation value) or falls below the lower limit (black level) of the photodiode. As a result, collapsing of the dot pattern is avoided, and decrease in parallax detection rate can be prevented.

### Alteration

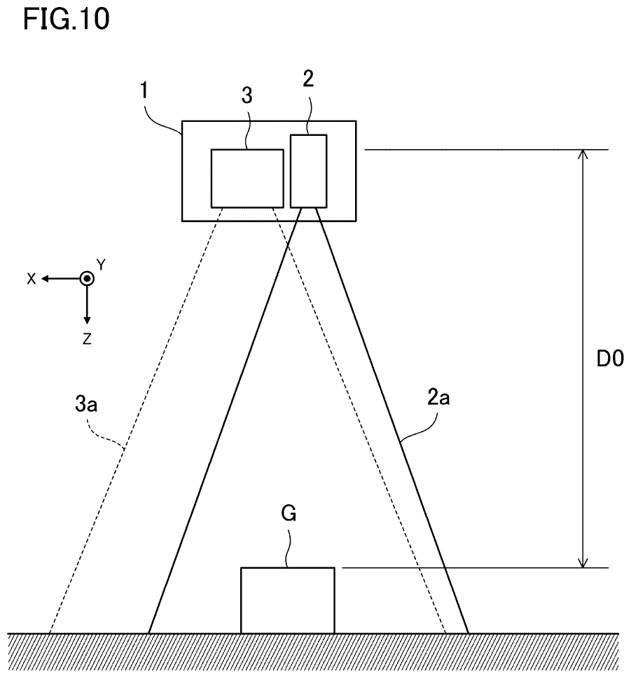

FIG. 10 shows a configuration according to an alteration of the distance measuring device 1. The configuration of FIG. 10 has one imaging unit 3, different from the configuration of FIG. 1 having two imaging units 3. In this alteration, parallax information is generated according to the flow in FIG. 3 based on the random dot pattern projected by the projecting unit 2 and the image captured by the imaging unit 3, that is, stereo matching is executed. More specifically, in step S7 in FIG. 3 in the above embodiment, the distance to the object G is measured based on two first images when two imaging units 3 are used. By contrast, in this alteration, the distance to the object G is measured based on the first image captured by the imaging unit 3 and the random dot pattern projected by the projecting unit 2. The other configuration and operation are similar to those in the first embodiment, and similar effects are obtained.

### Second Embodiment

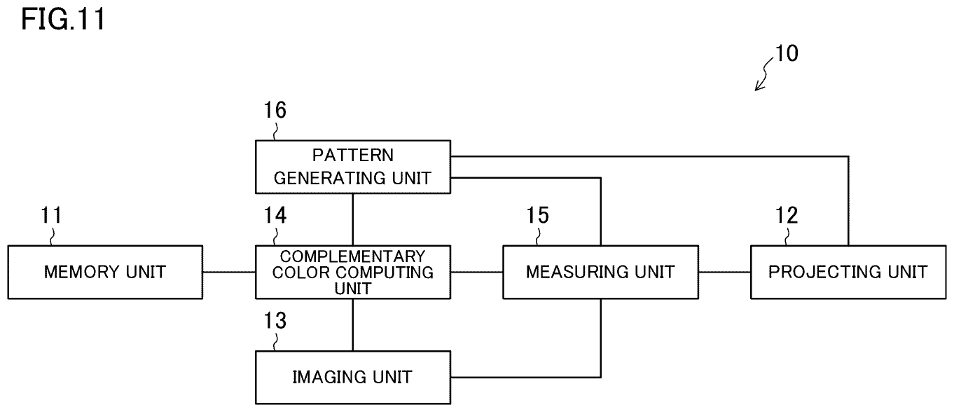

FIG. 11 is a block diagram showing an example of the configuration of an imaging device 10 according to this embodiment. Note that description may be simplified or omitted in some cases for configurations in common with the first embodiment.

As shown in FIG. 11, the imaging device 10 includes a memory unit 11, a projecting unit 12, an imaging unit 13, a complementary color computing unit 14, a measuring unit 15, and a pattern generating unit 16. The projecting unit 12 and the imaging unit 13, for example, are arranged and configured similarly to the projecting unit 2 and the imaging unit 3 in FIG. 10 described above. The functions of the complementary color computing unit 14, the measuring unit 15, and the pattern generating unit 16 are implemented by the processor described above, for example.

### Memory Unit

Color information of the object is stored in the memory unit 11. In the first embodiment, color information is acquired by imaging the object under projection of uniform light. However, by storing color information of the object G in the memory unit 11 as in this embodiment, the number of frames imaged can be reduced.

### Complementary Color Computing Unit

The complementary color computing unit 14 computes a complementary color to the color of the object G using the color information of the object G stored in the memory unit 11.

Note that the complementary color computing unit 14 may acquire color information of the object, by projecting uniform light onto the object by the projecting unit 12 and imaging the object by the imaging unit 13 under projection of the uniform light, and compute a complementary color to the color of the object using the acquired color information. When the uniform light captured by the imaging unit 13 is used for computation of the complementary color, it is unnecessary to provide the memory unit 11.

### Pattern Generating Unit

The pattern generating unit 16 generates a random dot pattern of the complementary color computed by the complementary color computing unit 14 and outputs the generated pattern to the projecting unit 12. The projecting unit 12 projects the random dot pattern input from the pattern generating unit 16 or uniform light onto the object G. The imaging unit 13 images the object G under projection of the light (the random dot pattern or uniform light) by the projecting unit 12. The image captured by the imaging unit 13 is output to the measuring unit 15.

### Measuring Unit

The measuring unit 15 identifies the region of the object G from the image input from the imaging unit 13. For example, when the object G is distant from the background, the random dot pattern is projected only onto the object G, not projected onto the background. Therefore, the region in which the object G is present can be easily identified.

### Imaging Method

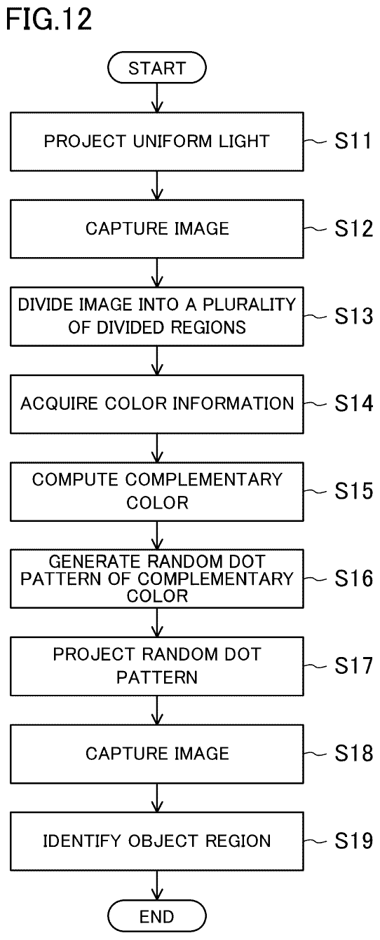

An imaging method using the imaging device 10 will be described hereinafter with reference to FIGS. 12 to 14. The imaging device 10 includes at least one processor and has a program for executing the following method, for example.

Note that, in FIGS. 12 to 14, common operations are denoted by the same reference characters. The following description will be made centering on differences from the “operation of the parallax information generating device” described earlier and differences among FIGS. 12 to 14, and duplicate description may be omitted.

### No. 1

FIG. 12 shows an example of the imaging method in which color information of the object is acquired from the results of imaging under projection of uniform light.

Specifically, in FIG. 12, uniform light is projected onto the object G from the projecting unit 12 (step S11), and the object G under projection of the uniform light is imaged by the imaging unit 13, to acquire color information of the object G (step S12). Steps S11 and S12 respectively correspond to steps S1 and S2 in FIG. 3, and specifics of the processing are similar to those in steps S1 and S2.

The complementary color computing unit 14 divides the image captured in step S12 into a plurality of divided regions (step S13), acquires color information of the object G for each divided region RD (step S14), and computes the corresponding complementary color for each divided region RD (step S15). The processing in steps S13 to S15 corresponds to the processing in step S3 in FIG. 3, and a computation method similar to that in the first embodiment can be used.

In step S16, the pattern generating unit 16 generates a random dot pattern of the complementary color for each divided region RD computed by the complementary color computing unit 14, and outputs the generated pattern to the projecting unit 12. Step S16 corresponds to step S4 in FIG. 3, and specifics of the processing are similar to those in step S4.

In step S17, the projecting unit 12 projects the random dot pattern received from the pattern generating unit 16 onto the object G. Step S17 corresponds to step S5 in FIG. 3, and specifics of the processing are similar to those in step S5.

In step S18, the imaging unit 13 images the object G under projection of the random dot pattern. Step S17 corresponds to step S5 in FIG. 3, and specifics of the processing are similar to those.

In step S19, the measuring unit 15 identifies the region of the object G from the image output from the imaging unit 13. That is, the region in which the object G is present in the image is identified. As described above, when the object G is distant from the background, for example, the random dot pattern is projected only onto the object G, not projected onto the background. Therefore, the region of the object G can be easily identified.

### No. 2

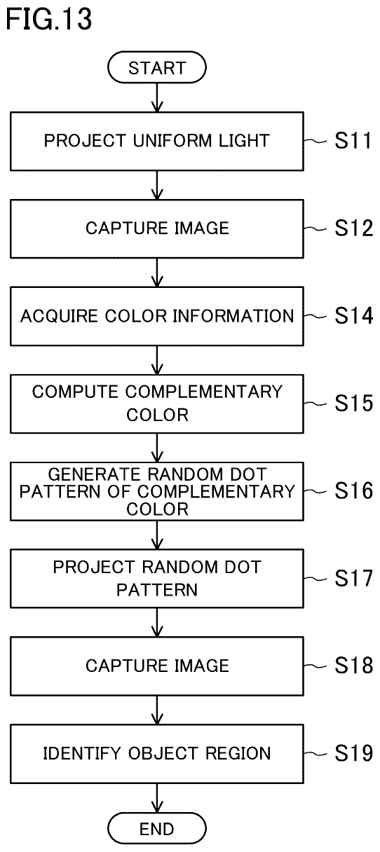

The imaging method of FIG. 13 is different from that of FIG. 12 in that the division of the image into the divided regions RD in step S13 is omitted. That is, in FIG. 13, the image captured in step S12 is not divided into the divided regions RD, but the entire image is subjected to the subsequent process steps.

The ways of processing in steps S14 to S19 are similar to those in the method No. 1 although there is a difference in whether the processing is performed for each divided region RD or for the entire image.

### No. 3

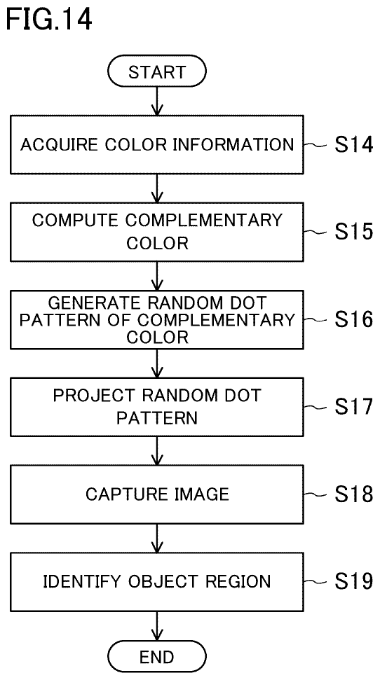

The imaging method of FIG. 14 is different from that of FIG. 13 in that color information of the object stored in the memory unit 11 is used in place of acquiring color information of the object from the results of imaging under projection of uniform light.

That is, steps S11 and S12 in FIG. 13 are omitted, and in step S14, the complementary color computing unit 14 acquires color information from the memory unit 11.

The subsequent processing (steps S15 to S19) is similar to that in the method No. 1 or No. 2 described above, and therefore detailed description is omitted here.

### Alteration

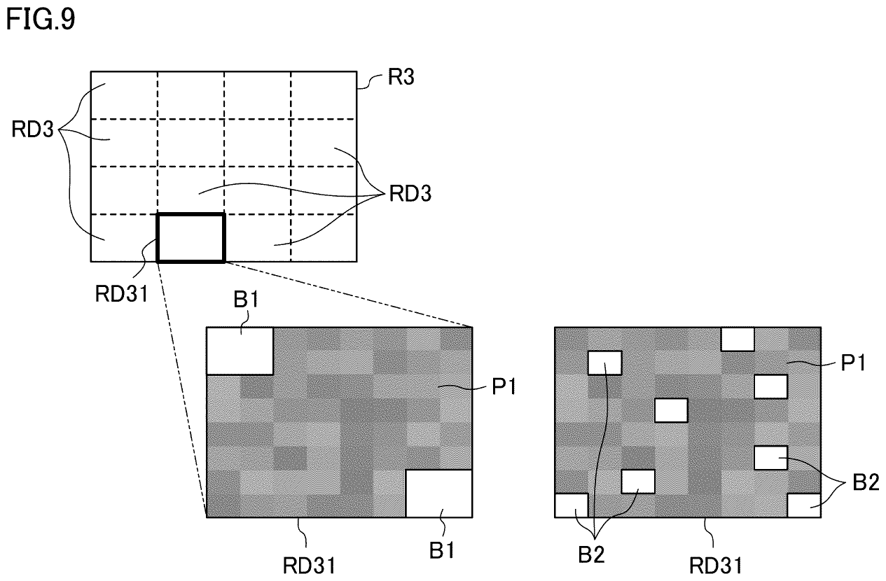

In the imaging methods No. 1 to No. 3 described above, the projecting unit 12 may project an integrated random dot pattern P1 including a region in which uniform light is projected, as part of the pattern, for some or all of the divided regions RD. FIG. 9 shows examples of the integrated random dot pattern P1.

FIG. 9 shows, in one (region RD31) of divided regions RD3 within a projection range R3, an example (1) of the integrated random dot pattern P1 in which regions B1 for projecting uniform light are provided in the upper-left corner and the lower-right corner of the random dot pattern light, and an example (2) of the integrated random dot pattern P1 in which regions B2 for projecting uniform light are provided in a patchy pattern in the random dot pattern light.

With the above configuration, the complementary color information of the divided regions RD3 can be updated from information of the pixels for which uniform light is being projected, such as the regions B1 or the regions B2, without the necessity of newly projecting uniform light.

### Third Embodiment

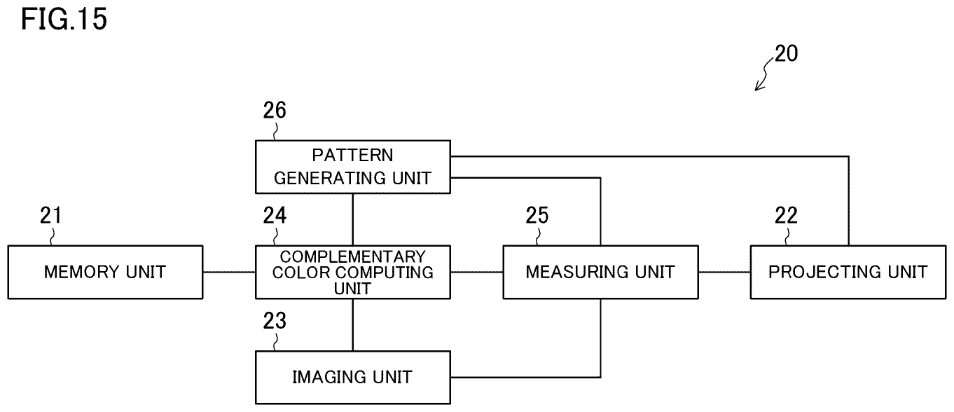

FIG. 15 is a block diagram showing an example of the configuration of an inspecting device 20 according to this embodiment. Note that the following description will be made centering on differences from the second embodiment, and description may be simplified or omitted in some cases for configurations in common with the second embodiment.

As shown in FIG. 15, the inspecting device 20 includes a memory unit 21, a projecting unit 22, an imaging unit 23, a complementary color computing unit 24, a measuring unit 25, and a pattern generating unit 26. The memory unit 21, the projecting unit 22, the imaging unit 23, the complementary color computing unit 24, and the pattern generating unit 26, for example, are arranged and configured similarly to the memory unit 11, the projecting unit 12, the imaging unit 13, the complementary color computing unit 14, and the pattern generating unit 16 in FIG. 11 described above. In this embodiment, the functions of the complementary color computing unit 24, the measuring unit 25, and the pattern generating unit 26 are implemented by the processor described above, for example.

### Measuring Unit

The measuring unit 25 detects a defect of the object G from the image captured by the imaging unit 23. For example, the measuring unit 25 detects, as a defect, a deformation of the pattern when the degree of the deformation exceeds a predetermined threshold. Since a deformation of the pattern occurs when the object G has a distortion or when the surface of the object G has a flaw, for example, the measuring unit 25 can detect such a defect.

### Inspecting Method

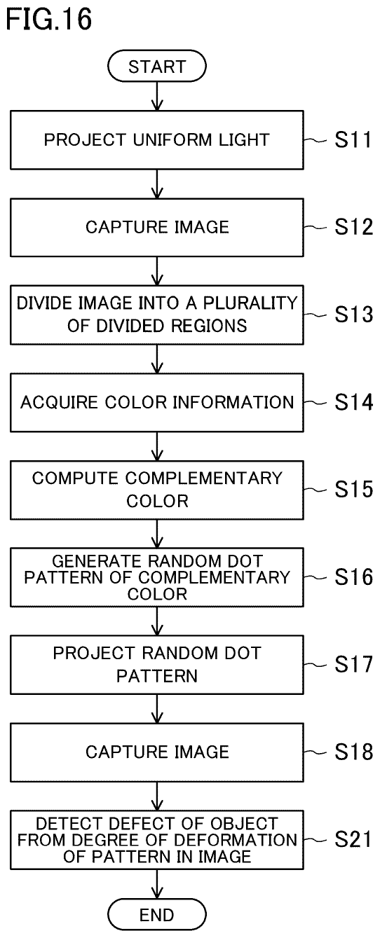

An inspecting method using the inspecting device 20 will be described hereinafter with reference to FIGS. 16 to 18. The inspecting device 20 includes at least one processor and has a program for executing the following method, for example.

Note that, in FIGS. 16 to 18, common operations with FIGS. 12 to 14 and common operations among FIGS. 16 to 18 are denoted by the same reference characters. The following description will be made centering on differences from the second embodiment and differences among FIGS. 16 to 18, and duplicate description may be omitted.

### No. 1

FIG. 16 shows an example of the inspecting method in which color information of the object G is acquired from the results of imaging of the object G under projection of uniform light.

In FIG. 16, steps S11 to S18 correspond to steps S11 to S18 in FIG. 12, and specifics of the processing are similar to those in FIG. 12. In FIG. 16, step S21 is executed next to step S18.

In step S21, the measuring unit 25 detects a defect of the object G from the image output from the imaging unit 23. As described above, the measuring unit 25 detects, as a defect, a deformation of the pattern when the degree of the deformation exceeds a predetermined threshold, in the image output from the imaging unit 23, for example.

### No. 2

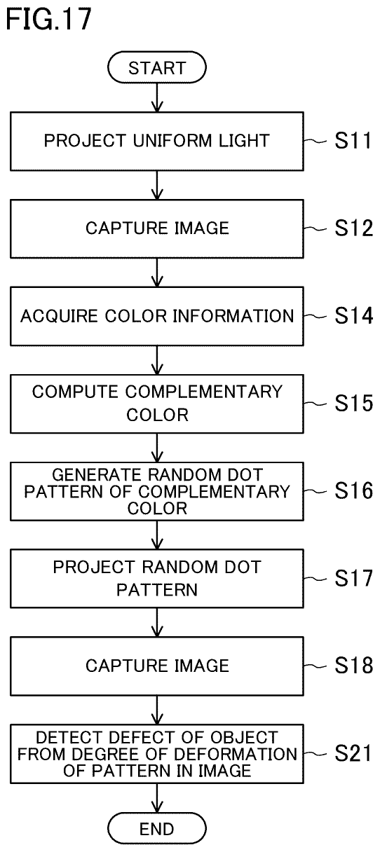

The inspecting method of FIG. 17 is different from that of FIG. 16 in that the division of the image into the divided regions RD in step S13 is omitted. That is, in FIG. 17, the image captured in step S12 is not divided, but the entire image is subjected to the subsequent process steps.

For steps S14 to S18 and S21, ways of processing similar to those in the method No. 1 can be used although there is a difference in whether the processing is performed for each divided region RD or for the entire image.

### No. 3

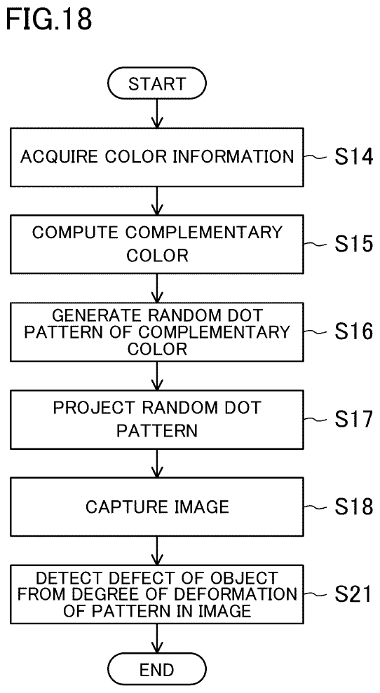

The inspecting method of FIG. 18 is different from that of FIG. 17 in that color information of the object G stored in the memory unit 21 is used in place of acquiring color information of the object G from the results of imaging under projection of uniform light.

That is, steps S11 and S12 in FIG. 17 are omitted in FIG. 18, and in step S14, the complementary color computing unit 24 acquires color information of the object G from the memory unit 21.

The subsequent processing (steps S15 to S18 and S21) is similar to that in the method No. 1 or No. 2 described above, and therefore detailed description is omitted here.

### Alteration

In the inspecting methods No. 1 to No. 3 described above, the projecting unit 22 may project an integrated random dot pattern P1 including a region in which uniform light is projected, as part of the pattern, for some or all of the divided regions RD. An example of the integrated random dot pattern P1 is shown in FIG. 9 as described above.

### Fourth Embodiment

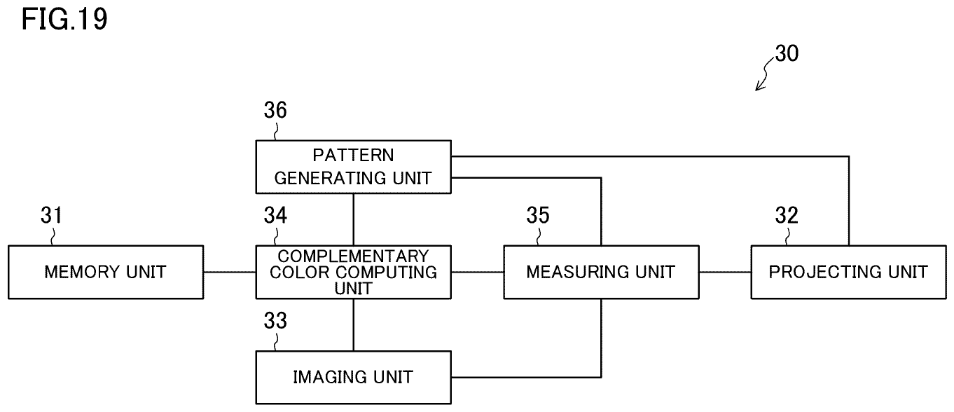

FIG. 19 is a block diagram showing an example of the configuration of a distance measuring device 30 according to this embodiment. Note that the following description will be made centering on differences from the second embodiment, and description may be simplified or omitted in some cases for configurations in common with the second embodiment.

As shown in FIG. 19, the distance measuring device 30 includes a memory unit 31, a projecting unit 32, an imaging unit 33, a complementary color computing unit 34, a measuring unit 35, and a pattern generating unit 36. In this embodiment, the memory unit 31, the projecting unit 32, the imaging unit 33, the complementary color computing unit 34, and the pattern generating unit 36 are arranged and configured similarly to the projecting unit 11, the projecting unit 12, the imaging unit 13, the complementary color computing unit 14, and the pattern generating unit 16 in FIGS. 10 and 11 described above. The projecting unit 32 here is a structured light system, for example. In this embodiment, the functions of the complementary color computing unit 34, the measuring unit 35, and the pattern generating unit 36 are implemented by the processor described above, for example.

### Measuring Unit

The measuring unit 35 computes the distance to the object G using the image captured by the imaging unit 33. Specifically, the measuring unit 35 computes the parallax between the pattern on the image output from the imaging unit 33 and the projection pattern projected by the projecting unit 32, and computes the distance to the object G from the computed parallax.

### Distance Measuring Method

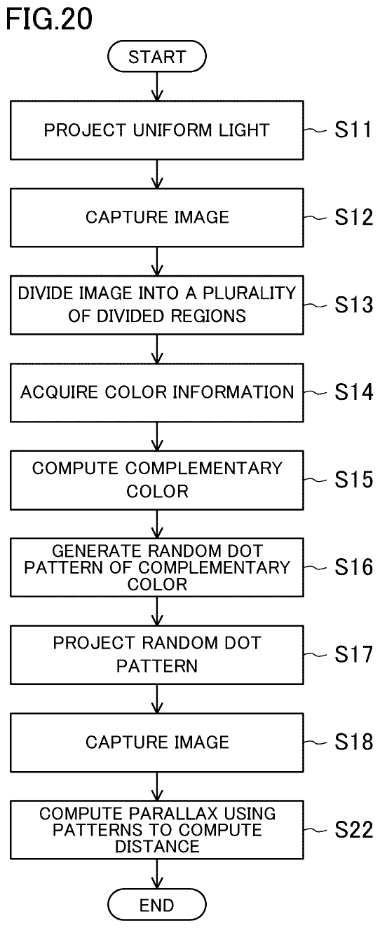

A distance measuring method using the distance measuring device 30 will be described hereinafter with reference to FIGS. 20 to 22. The measuring device 30 includes at least one processor and has a program for executing the following distance measuring method, for example.

Note that, in FIGS. 20 to 22, common operations with FIGS. 12 to 14 and common operations among FIGS. 20 to 22 are denoted by the same reference characters. The following description will be made centering on differences from the second embodiment and differences among FIGS. 20 to 22, and duplicate description may be omitted.

### No. 1

FIG. 20 shows an example of the distance measuring method in which color information of the object is acquired from the results of imaging under projection of uniform light.

In FIG. 20, steps S11 to S18 correspond to steps S11 to S18 in FIG. 12 and specifics of the processing are similar to those in FIG. 12. In FIG. 20, step S22 is executed next to step S18.

In step S22, the measuring unit 35 computes the distance to the object G using the image output from the imaging unit 33. As described above, the measuring unit 35 computes the parallax between the pattern on the image output from the imaging unit 33 and the projection pattern projected by the projecting unit 32, and computes the distance to the object G from the computed parallax.

### No. 2

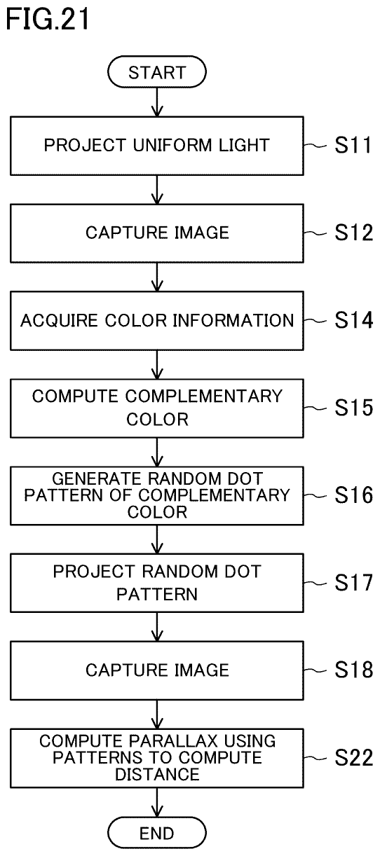

The distance measuring method of FIG. 21 is different from that of FIG. 20 in that the division of the image into the divided regions RD in step S13 is omitted. That is, in FIG. 21, the image captured in step S12 is not divided into the divided regions RD but the entire image is subjected to the subsequent process steps.

The ways of processing in steps S14 to S18 and S22 are similar to those in the method No. 1 although there is a difference in whether the processing is performed for each divided region RD or for the entire image.

### No. 3

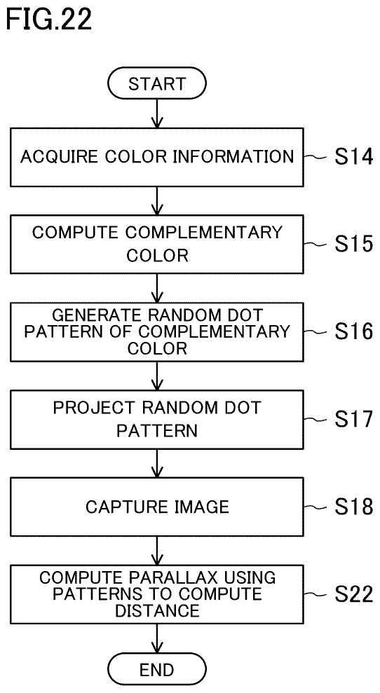

The inspecting method of FIG. 22 is different from that of FIG. 21 in that color information of the object stored in the memory unit 31 is used in place of acquiring color information of the object from the results of imaging under projection of uniform light.

That is, in FIG. 22, steps S11 and S12 in FIG. 21 are omitted, and in step S14, the complementary color computing unit 34 acquires color information from the memory unit 31.

The subsequent processing (steps S15 to S18 and S22) is similar to that in the method No. 1 or No. 2 described above, and therefore detailed description is omitted here.

### Alteration 1

In the inspecting methods No. 1 to No. 3 described above, the projecting unit 22 may project an integrated random dot pattern P1 including a region in which uniform light is projected, as part of the pattern, for some or all of the divided regions RD. An example of the integrated random dot pattern P1 is shown in FIG. 9 as described above.

### Alteration 2

While the above fourth embodiment describes an example in which light is projected onto the object G using a structured light system as the projecting unit 32 and the single imaging unit 33 images the object G under projection of light (a random dot pattern or uniform light) as shown in FIG. 10, the configuration is not limited to this.

For example, as described in the first embodiment (e.g., see FIG. 1), two imaging units 33 may be used. The configuration of this alteration is used for a stereo camera, for example.

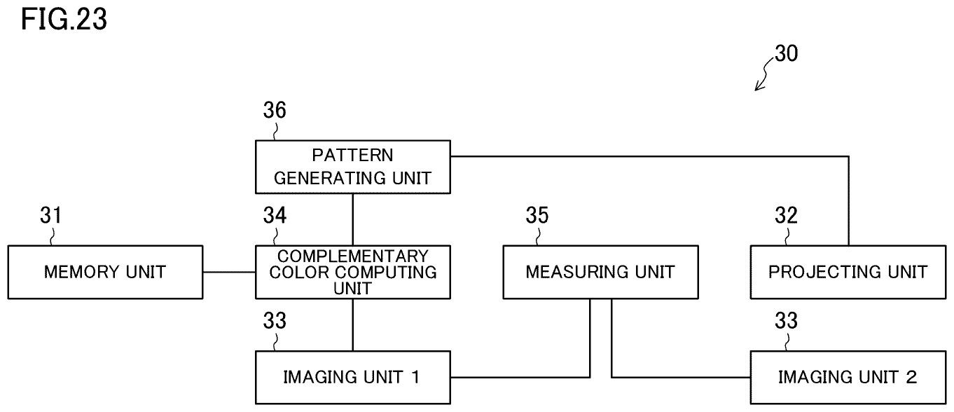

FIG. 23 is a block diagram showing an example of the configuration of the distance measuring device 30 according to this alteration. Note that the following description will be made centering on differences from the fourth embodiment, and description may be simplified or omitted in some cases for configurations in common with the fourth embodiment.

As shown in FIG. 23, the distance measuring device 30 of this alteration is different from the configuration of FIG. 19 in having two imaging units 33. Also, the method of computing the distance by the measuring unit 35 is different from that in the fourth embodiment.

### Measuring Unit

The measuring unit 35 computes the distance to the object G using images captured by the imaging units 33. Specifically, the measuring unit 35 computes the parallax between the two images captured by the two imaging units 33 placed at positions different in visual point using the patterns appearing on the two images, and computes the distance to the object G from the computed parallax.

The distance measuring method according to this alteration is similar to those in the methods No. 1 to No. 3 in the fourth embodiment in steps S11 to S18, but is different in step S22.

Specifically, in this alteration, in step S22, the measuring unit 35 computes the distance to the object G using the images captured by the two measuring units 33. As described above, the measuring unit 35 computes the parallax between the two images captured by the two imaging units 33 placed at positions different in visual point using the patterns appearing on the two images, and computes the distance to the object G from the computed parallax.

### Alteration 3

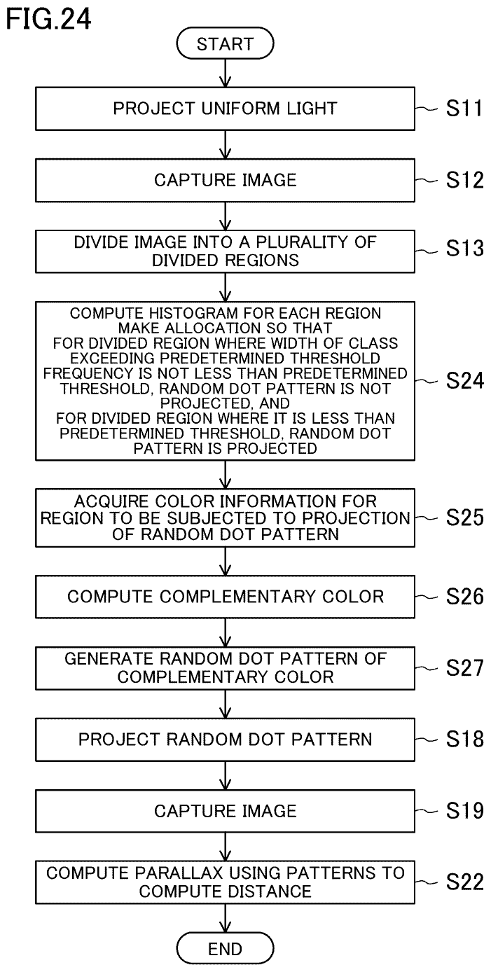

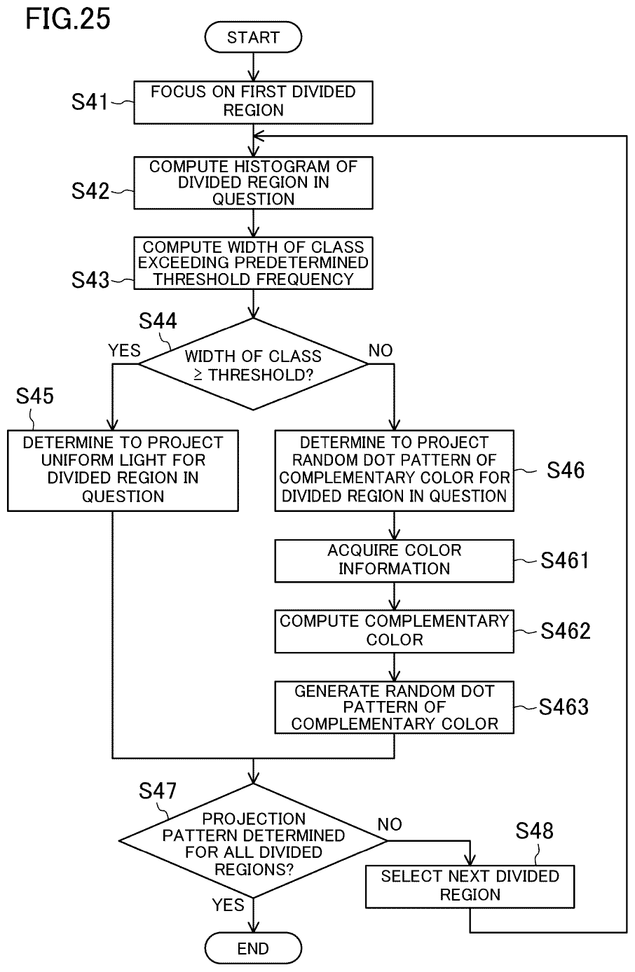

FIGS. 24 and 25 are flowcharts showing an example of the distance measuring method according to this alteration. FIG. 24 is a flowchart corresponding to FIG. 20. The measuring device 30 includes at least one processor and has a program for executing the following distance measuring method, for example.

Note that, in FIG. 24, common operations with FIG. 20 are denoted by the same reference characters. The following description will be made centering on differences from the fourth embodiment, and duplicate description may be omitted.

Steps S11 to S13 in FIG. 24 correspond to steps S11 to S13 in FIG. 20, and specifics of the processing are similar to those in FIG. 20. In FIG. 24, step S24 is executed next to step S13.

In step S24, the processor determines a histogram for each divided region RD using the image of the object G captured under projection of uniform light. For a divided region RD having a histogram in which the width of a class having a frequency exceeding a predetermined threshold frequency is equal to or more than a predetermined threshold, the distance to the object G is measured using the image captured under projection of uniform light. On the other hand, for a divided region RD having a histogram in which the width of a class having a frequency exceeding the predetermined threshold frequency is less than the predetermined threshold, the distance to the object G is measured using an image captured under projection of a random dot pattern.

FIG. 25 is a flowchart showing in detail the processing of step S24 in FIG. 24.

First, the processor focuses on the first divided region (step S41), and computes a histogram of the divided region RD in question (step S42). The processor also computes the width of a class having a frequency exceeding a predetermined threshold (step S43).

In next step S44, the processor determines whether or not the width of the class computed in step S43 is equal to or more than a predetermined threshold. If the width of the class is equal to or more than the predetermined threshold (YES in S44), uniform light is to be projected for the divided region in question (step S45), and the flow proceeds to step S47. On the other hand, if the width of the class is less than the predetermined threshold (NO in S44), a random dot pattern is to be projected for the divided region in question (step S46), and processing in steps S461 to S463 is executed.

Specifically, the processor acquires color information of the object G in the divided region RD in question (step S461), and computes a complementary color corresponding to the divided region RD (step S462). Further, the processor generates a random dot pattern of a complementary color for the divided region RD in question from the complementary color computed in step S462, and the flow proceeds to step S47.

In step S47, whether or not projection patterns for all the divided regions RD have been determined is determined. If there is a divided region RD not yet subjected to determination of a projection pattern (NO in step S47), a next divided region RD to be focused on is selected, and the processing of steps S42 to S48 is repeated until projection patterns for all the divided regions RD have been determined.

Once projection patterns for all the divided regions RD have been determined (NO in S47), the processing of step S24 in FIG. 24 is finished, and the flow proceeds to next step S25.

In step S25, the processor acquires color information for a region for which projection of a complementary color random dot pattern has been determined in step S24, that is, a region to be subjected to projection of a random dot pattern. The processor then computes a corresponding complementary color for each divided region RD subjected to projection of a random dot pattern (step S26), generates a random dot pattern of the complementary color (step S27), and outputs the generated pattern to the projecting unit 12. The processing of steps S25 and S26 corresponds to step S3 in FIG. 3, the processing of step S27 corresponds to step S3 in FIG. 3, and methods similar to those in the first embodiment can be used.

Next to step S27, the flow proceeds to step S18. Steps S18, S19, and S22 in FIG. 24 correspond to steps S18, S19, and S22 in FIG. 20, and specifics of the processing are similar to those in FIG. 20.

### Other Embodiment

The present disclosure is not limited to the embodiments described above, but various modifications may be made without departing from the spirit of the disclosure. Also, the above embodiments and/or alterations may be combined in various ways, to present a new embodiment.

For example, in addition to the configuration in the first embodiment, the measuring unit 5 may determine a histogram for each divided region RD using the second image captured under projection of uniform light. In the histogram of the second image, for a divided region RD in which the width W of a class having a frequency exceeding a predetermined threshold frequency Bt is equal to or more than a predetermined threshold Wt, the distance to the object G may be measured using the second images. On the other hand, for a divided region RD in which the width W of a class having a frequency exceeding the predetermined threshold frequency Bt is less than the predetermined threshold Wt, the distance to the object G may be measured using the first images captured under projection of a random dot pattern.

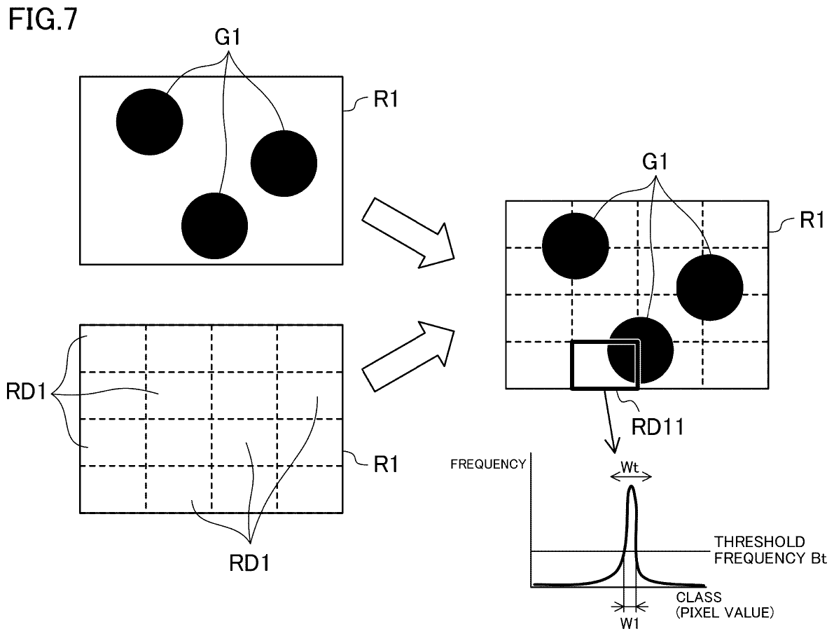

FIG. 7 shows an example in which, in a divided region RD1 within a projection range R1 including an object G1, the width W1 of a class is less than a predetermined threshold Wt, that is, an example in which the width in the histogram is smaller than a predetermined width. For such a divided region RD1, the measuring unit 5 measures the distance to the object G using the first images captured under projection of a random dot pattern.

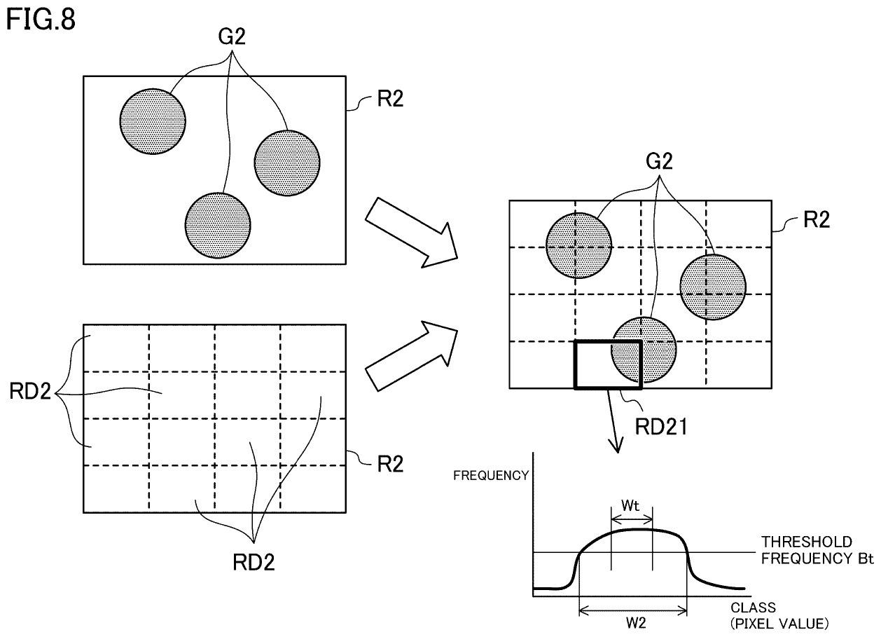

On the other hand, as shown in FIG. 8, in a divided region RD2 within a projection range R2 including an object G2, when the width W2 of a class is equal to or more than a predetermined threshold Wt, that is, when the width in the histogram is larger than a predetermined width, the measuring unit 5 measures the distance to the object G2 using the second images captured under projection of uniform light.

With the above configuration, the calculation time can be shortened, and/or the number of times of projection of frames can be reduced in some cases. Therefore, the effect that the processing time can be shortened is obtained.

Also, while, in the first embodiment, the projecting unit 2 projects the random dot pattern generated by the pattern generating unit 6 in step S5 in FIG. 3 onto the projection range 2a, the operation is not limited to this. For example, the projecting unit 2 may project the integrated random dot pattern P1 for some or all of the divided regions RD. The integrated random dot pattern P1 is a pattern including a region in which uniform light is projected as part of the random dot pattern light generated by the pattern generating unit 6, i.e., a pattern in which projection regions of random dot pattern light and uniform light are integrated (see FIG. 9).

While, in the first embodiment, described is an example in which the measuring unit 5 divides the second image acquired in the imaging unit 3 into a plurality of divided regions RD and determines a corresponding complementary color for each divided region RD, the operation is not limited to this. For example, the measuring unit 5 may determine the complementary color to the object G using the second image captured by one of the imaging units 3 under projection of uniform light onto the object G from the projecting unit 2, and output the resultant complementary color to the pattern generating unit 6. In this case, the complementary color is to be calculated using the entire region of the second image in step S3 in FIG. 3. The other steps are similar to those described in the embodiment, and similar results are obtained. This method is applicable to a case where the spectral reflectance within the imaging range of the object is constant, for example.

Since the distance measuring device according to the present disclosure can prevent decrease in parallax detection rate, it can be used for stereo cameras and the like. The present disclosure is therefore highly useful.

1. An imaging method, comprising:
computing a complementary color to the color of an object;
generating a random dot pattern of the complementary color and projecting the random dot pattern onto the object; and
imaging the object and identifying an image region of the object using a random dot pattern obtained by the imaging.

2. The imaging method of claim 1, comprising:
projecting uniform light onto the object;
acquiring color information of the object by imaging the object under projection of the uniform light; and
computing the complementary color to the color of the object using the color information.

3. An imaging method, comprising:
projecting uniform light onto the object; and
imaging the object under projection of the uniform light, dividing a captured image into a plurality of divided regions, and executing the imaging method of claim 1 for each of the divided regions.

4. The imaging method of claim 3, wherein
the random dot pattern is an integrated random dot pattern partly including a region in which uniform light is projected.

5. A program for making an imaging device including at least one processor execute the imaging method of claim 1.

6. An imaging device, comprising:
a complementary color computing unit configured to compute a complementary color to the color of an object;
a pattern generating unit configured to generate a random dot pattern of the complementary color;
a projecting unit configured to project the random dot pattern of the complementary color onto the object;
an imaging unit configured to image the object; and
a measuring unit configured to identify a region of the object from an image output from the imaging unit.

7. The imaging device of claim 6, wherein
the complementary color computing unit computes the complementary color to the color of the object using a second image acquired by the imaging unit under projection of uniform light by the projecting unit.

8. The imaging device of claim 7, wherein
the complementary color computing unit divides the second image into a plurality of divided regions and computes the complementary color to the color of the object for each of the divided regions.

9. The imaging device of claim 8, wherein
the random dot pattern is an integrated random dot pattern partly including a region in which uniform light is projected.

10. An inspecting method, comprising:
computing a complementary color to the color of an object;
generating a random dot pattern of the complementary color and projecting the random dot pattern onto the object; and
imaging the object and detecting a defect of the object using a random dot pattern obtained by the imaging.

11. The inspecting method of claim 10, comprising:
projecting uniform light onto the object;
acquiring color information of the object by imaging the object under projection of the uniform light; and
computing the complementary color to the color of the object using the color information.

12. An inspecting method, comprising:
projecting uniform light onto the object; and
imaging the object under projection of the uniform light, dividing a captured image into a plurality of divided regions, and executing the inspecting method of claim 10 for each of the divided regions.

13. The inspecting method of claim 12, wherein
the random dot pattern is an integrated random dot pattern partly including a region in which uniform light is projected.

14. A program for making an inspecting device including at least one processor execute the inspecting method of claim 10.

15. An inspecting device, comprising:
a complementary color computing unit configured to compute a complementary color to the color of an object;
a pattern generating unit configured to generate a random dot pattern of the complementary color;
a projecting unit configured to project the random dot pattern of the complementary color onto the object;
an imaging unit configured to image the object; and
a measuring unit configured to detect a defect of the object from an image output from the imaging unit.

16. The inspecting device of claim 15, wherein
the complementary color computing unit computes the complementary color to the color of the object using a second image acquired by the imaging unit under projection of uniform light by the projecting unit.

17. The inspecting device of claim 16, wherein
the complementary color computing unit divides the second image into a plurality of divided regions and computes the complementary color to the color of the object for each of the divided regions.

18. The inspecting device of claim 17, wherein
the random dot pattern is an integrated random dot pattern partly including a region in which uniform light is projected.

19. A distance measuring method, comprising:
computing a complementary color to the color of an object;
generating a random dot pattern of the complementary color and projecting the random dot pattern onto the object; and
imaging the object and computing a distance to the object using a random dot pattern obtained by the imaging.

20. The distance measuring method of claim 19, comprising:
projecting uniform light onto the object;
acquiring color information of the object by imaging the object under projection of the uniform light; and
computing the complementary color to the color of the object using the color information.

21. A distance measuring method, comprising:
projecting uniform light onto the object; and
imaging the object under projection of the uniform light, dividing a captured image into a plurality of divided regions, and executing the distance measuring method of claim 19 for each of the divided regions.

22. The distance measuring method of claim 21, wherein
the random dot pattern is an integrated random dot pattern partly including a region in which uniform light is projected.

23. The distance measuring method of claim 21, wherein
a histogram is determined for each of the divided regions using the image acquired under projection of uniform light,
for a divided region having a histogram in which the width of a class having a frequency exceeding a predetermined threshold frequency is equal to or more than a predetermined threshold, the distance to the object is measured using the image acquired under projection of the uniform light, and
for a divided region having a histogram in which the width of a class having a frequency exceeding the predetermined threshold frequency is less than the predetermined threshold, the distance to the object is measured using an image acquired under projection of the random dot pattern.

24. A program for making a distance measuring device including at least one processor execute the distance measuring method of claim 19.

25. A distance measuring device, comprising:
a complementary color computing unit configured to compute a complementary color to the color of an object;
a pattern generating unit configured to generate a random dot pattern of the complementary color;
a projecting unit configured to project the random dot pattern of the complementary color onto the object;
an imaging unit configured to image the object; and
a measuring unit configured to measure the distance to the object from an image output from the imaging unit.

26. The distance measuring device of claim 25, wherein
the complementary color computing unit computes the complementary color to the color of the object using a second image acquired by the imaging unit under projection of uniform light by the projecting unit.

27. The distance measuring device of claim 26, wherein
the complementary color computing unit divides the second image into a plurality of divided regions and computes the complementary color to the color of the object for each of the divided regions.

28. The distance measuring device of claim 27, wherein
the random dot pattern is an integrated random dot pattern partly including a region in which uniform light is projected.

29. The distance measuring device of claim 27, wherein
a histogram is determined for each of the divided regions using the second image,
for a divided region having a histogram in which the width of a class having a frequency exceeding a predetermined threshold frequency is equal to or more than a predetermined threshold, the distance to the object is measured using the second image, and
for a divided region having a histogram in which the width of a class having a frequency exceeding the predetermined threshold frequency is less than the predetermined threshold, the distance to the object is measured using an image acquired by the imaging unit under projection of the random dot pattern by the projecting unit.
